(19) United States
(12) Patent Application Publication
(10) Pub. No.: US 2012/0140685 A1
(43) Pub. Date: Jun. 7, 2012

(54) SIMPLIFIED ADAPTIVE FILTER ALGORITHM FOR THE CANCELLATION OF TX-INDUCED EVEN ORDER INTERMODULATION PRODUCTS

(75) Inventors: Christian Lederer, Klagenfurt (AT); Huemer Mario, Alkoven (AT); Stefan Herzinger, Sauerlach (DE); Gernot Hueber, Linz (AT); Burkhard Neurauter, Linz (AT); Andreas Mayer, Linz (AT)

(73) Assignee: Infineon Technologies AG, Neubiberg (DE)

(21) Appl. No.: 12/957,612

(22) Filed: Dec. 1, 2010

(51) Int. Cl. H04B 3/20; G06F 17/10

(52) U.S. Cl. 370/286; 708/322

(57) ABSTRACT

One embodiment of the present invention relates to an adaptive filtering apparatus comprising first and second real valued adaptive filters, respectively configured to receive an adaptive filter input signal based upon a transmission signal in a transmission path. The first real valued adaptive filter is configured to operate a real valued adaptive filter algorithm on the input signal to estimate a first intermodulation noise component (e.g., an in-phase component) in a desired signal and to cancel the estimated noise. The second real valued adaptive filter is configured to operate a real valued adaptive filter algorithm on the input signal to estimate a second intermodulation noise component (e.g., a quadrature phase component) in the desired signal and to cancel the estimated noise. Accordingly, each filter operates a real valued adaptive algorithm to cancel a noise component, thereby removing complex cross terms between the components from the adaptive filtering process.

### BACKGROUND OF THE INVENTION

Over the past decade, the use of wireless communication devices has witnessed enormous growth to become commonplace in the daily lives of many. Many modern wireless communication devices (e.g., cell phones, PDAs, etc.) utilize transceivers having both a transmitter path (i.e., transmission chain) configured to transmit data and a receiver path (i.e., receiver chain) configured to receive data over radio frequencies.

Intermodulation noise or distortion may arise during the operation of such wireless communication devices. For example, second order intermodulation noise may occur in receiver chain when a modulated blocker passes a component with a nonlinear characteristic to form a spurious signal in the receiver chain. In such a case, the spurious signal within a receiver chain may contain harmful signal components that are detrimental to operation of the transceiver device.

### BRIEF DESCRIPTION OF THE DRAWINGS

FIG. 1 illustrates a block diagram of a wireless communication transceiver comprising a receiver path and a transmitter path and configured to operate in a full-duplex mode.

FIG. 2 illustrates a signal flow diagram of filtering performed by an adaptive filter configured to implement a complex adaptive filtering algorithm.

FIG. 3 illustrates a block diagram of a wireless communication transceiver comprising a simplified adaptive filtering system as provided herein.

FIG. 4 illustrates a more detailed block diagram of an adaptive filter configured to operate a real valued adaptive algorithm.

FIG. 5 illustrates a block diagram of an adaptive filtering system as provided herein applied to a polar modulation transceiver circuit.

FIG. 6 illustrates block diagram of an adaptive filtering system as provided herein applied to an I/Q modulation transceiver circuit.

FIG. 7 illustrates a signal flow diagram of filtering performed by two adaptive filters respectively configured to implement a real valued adaptive filtering algorithm.

FIG. 8 illustrates a block diagram of a transceiver having simplified adaptive filters configured to operate on a magnitude of a transmission signal.

FIG. 9 illustrates a block diagram of an adaptive filtering system as provided herein configured to operate real valued adaptive filtering algorithm in the analog domain.

FIG. 10 illustrates a block diagram of a transceiver circuit configured to cancel intermodulation noise using a combination of analog and digital processing techniques.

FIG. 11 illustrates a flow diagram showing a method for intermodulation noise cancellation.

### DETAILED DESCRIPTION OF THE INVENTION

The present invention will now be described with reference to the attached drawing figures, wherein like reference numerals are used to refer to like elements throughout, and wherein the illustrated structures and devices are not necessarily drawn to scale.

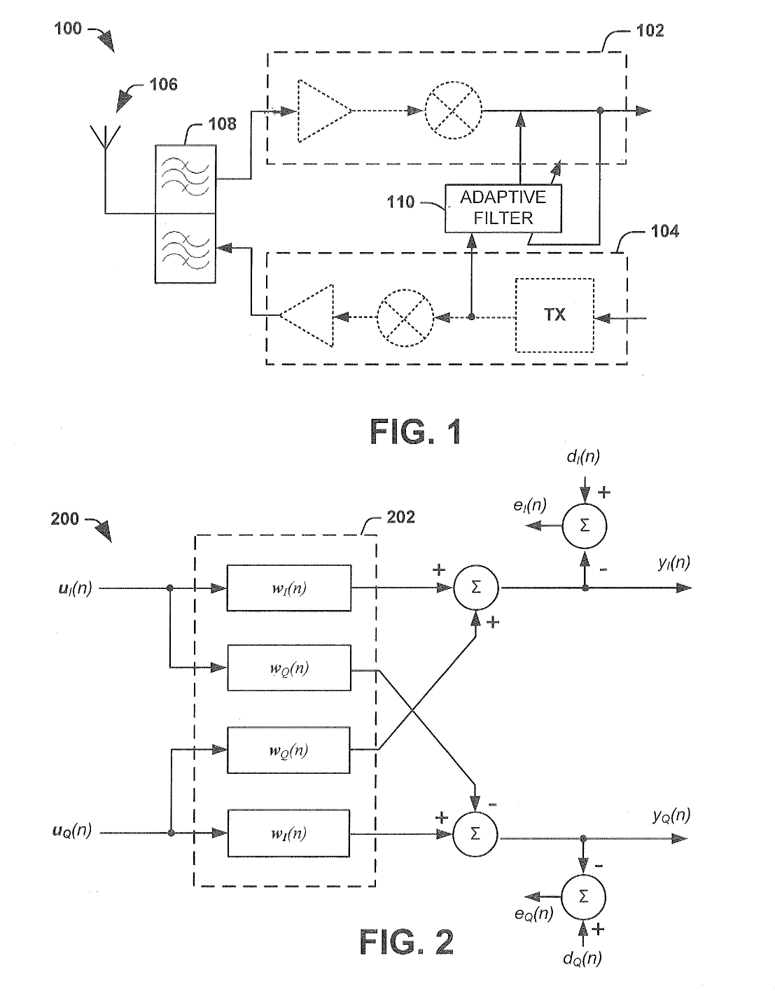

FIG. 1 illustrates a wireless communication transceiver 100 comprising a receiver section/path 102 and a transmitter section/path 104 Often, in order to reduce the hardware used by a wireless transceiver 100 (e.g., RF transceiver), the transmitter section 104 and the receiver section 102 may be configured to share a common antenna 106. A duplexer 108 may be configured to couple both the receiver path 102 and the transmitter path 104 to the common antenna 106. Furthermore, to achieve high data rates the transceiver 100 may be configured to operate in full-duplex mode, wherein both the receiver section 102 and the transmitter section 104 use the shared antenna 106 at the same time (e.g., a 3G system operating in a wideband code division multiple access (WCDMA) communication system may operate in a full-duplex mode).

During full duplex mode operation, the transmitter section 104 typically uses one carrier frequency in a given frequency band (e.g., 900 MHz, 1800 MHz, etc.) while the receiver section 102 uses another carrier frequency in the frequency band. Despite using different frequencies, intermodulation distortion may generate spurious signals (e.g., additional signals at frequencies that are not at harmonic frequencies of a received signal, but are instead at a sum and difference of the original signal frequency) in a receiver path that interfere with the operation of receiver signals. Therefore, a receiver 102 may be susceptible to intermodulation distortion (i.e., intermodulation noise) from a transmitted signal.

Intermodulation distortion can have a harmful effect on the operation of modern wireless communication systems. For example, in direct conversion receivers, second order intermodulation distortion (IM2) from the transmitted signal is a significant source of interference since it falls in the baseband occupied by a down converted receive signal.

Therefore, to minimize intermodulation noise in modern wireless communication systems an adaptive filter 110 (e.g., operating a least mean square (LMS) algorithm) may be configured to cancel intermodulation noise induced by the transmitter. The adaptive filter 110 is configured to estimate an intermodulation noise that is present in the receiver path 102, based upon an input signal from the transmission path 104, and to cancel the estimated noise from the receiver path 102. For example, the adaptive filter 110 may be used to operate a LMS algorithm that estimates and cancels the transmitter induced second-order intermodulation distortion (IM2). However, since the transmission path comprises a complex transmission baseband signal, normally an adaptive filter configured to implement a complex adaptive algorithm is needed.

FIG. 2 illustrates a signal flow diagram 200 of an adaptive filter 202 (e.g., corresponding to adaptive filter 110) configured to implement a complex filtering step in an adaptive algorithm (e.g., LMS algorithm) to cancel intermodulation noise in a receiver path caused by a modulated blocker (e.g., a complex transmission baseband signal). As shown in FIG. 2, the complex adaptive filtering system utilizes an adaptive filter 202, configured to receive an adaptive filter input signal having an in-phase component u_{I}(n) and a quadrature phase component u_{Q}(n), and to operate a complex filtering algorithm thereon. The adaptive filter 202 generates output signals y_{I}(n) and y_{Q}(n) that estimate an intermodulation noise based upon tap weight vectors w_{I}(n) and w_{Q}(n) of the filter 202, which may be iteratively updated through an error signals e_{I}(n) and e_{Q}(n).

Mathematically, this is described by generating an adaptive filter output signal y(n) that is equal to the input signal u(n) convolved with a tap weight vector w(n) (i.e., y(n)=w^{H}(n)×u(n)). The iterative nature of the process relies upon iteratively searching for a tap weight vector w(n) that optimizes the filtering operation. Therefore, a tap weight vector w(n) may be iteratively updated by stepping it by a value that is equal to the product of a step size μ (i.e., a convergence factor controlling the rate of adaption), the input signal u(n), and an error e(n) that is equal to the instantaneous difference between the output signal y(n) and a desired signal d(n) (i.e., w(n+1)=w(n)+μu(n)e(n), wherein e(n)=d(n)−y(n)).

As shown in FIG. 2, the complex adaptive algorithm generates cross terms between the in-phase components and the quadrature phase components during the filtering process, thereby resulting in an output signal of the adaptive filter having an in phase component that is equal to y_{I}(n)=w_{I}^{T}(n)u_{I}(n)+w_{Q}^{T}(n)u_{Q}(n) and having a quadrature phase component that is equal to y_{Q}(n)=w_{I}^{T}(n)u_{Q}^{T}(n)−w_{Q}^{T}(n)u_{I}(n).

The inventors have appreciated that removal of even-order TX intermodulation noise in a transceiver configured to operate in a full-duplex mode can be simplified through simplification of the adaptive filtering. Accordingly, a simplified adaptive filtering method and apparatus are provided herein. In one embodiment, the adaptive filtering apparatus comprises first and second real valued adaptive filters, respectively configured to receive an adaptive filter input signal based upon a baseband transmission signal in a transmission path. The first real valued adaptive filter is configured to operate a real valued adaptive filter algorithm on the input signal to estimate a first intermodulation noise component in a desired signal (e.g., a noise component that is distorting the in-phase component of a received baseband signal) and to cancel the estimated noise. The second real valued adaptive filter is configured to operate a real valued adaptive filter algorithm on the same input signal to estimate a second intermodulation noise component in the desired signal (e.g., a noise component that is distorting the quadrature phase component of a received baseband signal) and to cancel the estimated noise. Accordingly, each filter operates a real valued adaptive algorithm to cancel a component of an intermodulation noise generated by a transmission baseband signal, thereby removing complex cross terms between the components from the adaptive filtering process.

In one particular embodiment, an adaptive filtering apparatus is configured to comprise a first adaptive filter and a second adaptive filter respectively configured to receive an input signal and estimate in-phase (I) and quadrature phase (Q) components of the intermodulation noise. The first adaptive filter is configured to operate a real valued adaptive algorithm on the input signal to estimate an in-phase component of the intermodulation noise (e.g., a noise component that is distorting the in-phase component of a received baseband signal). The second adaptive filter is configured to operate the real valued adaptive algorithm on the input signal to estimate a quadrature-phase component of the intermodulation noise (e.g., a noise component that is distorting the quadrature-phase component of a received baseband signal). Therefore, the adaptive filters are configured to act independently of each other to filter the I and Q components of the intermodulation noise, so that the noise can be cancelled and filter coefficients can be updated for each filter independent of the other filter.

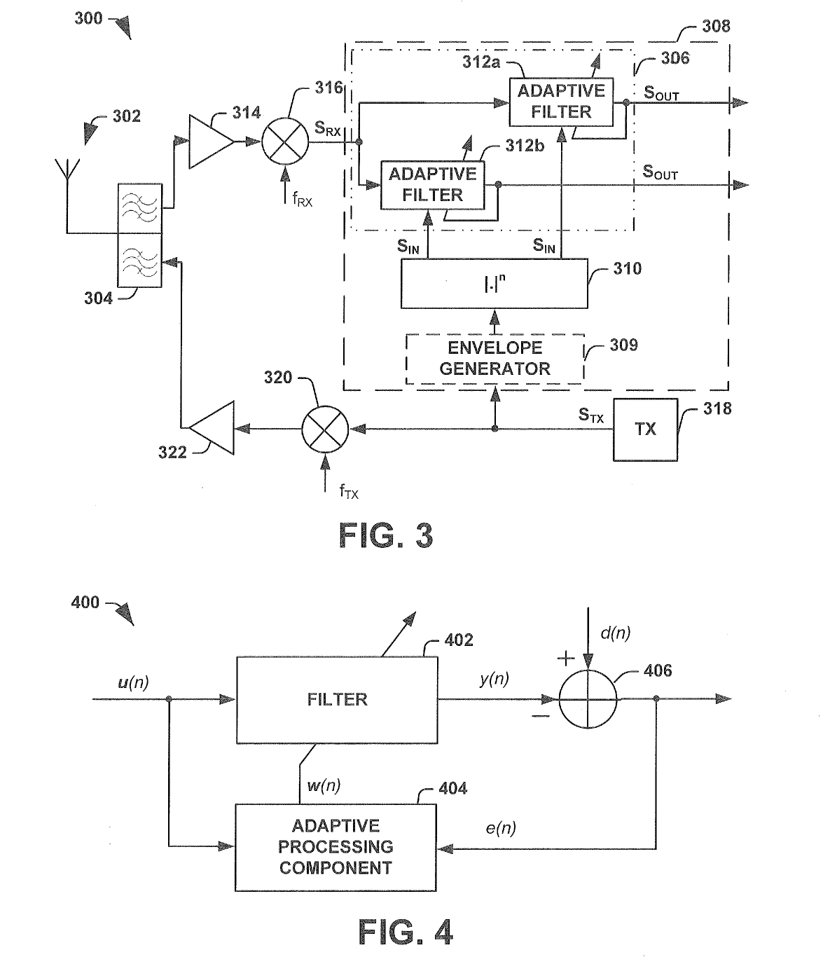

FIG. 3 illustrates a first embodiment of a transceiver 300 configured to implement a simplified adaptive filtering system as provided herein. The simplified adaptive filtering system is configured to adaptively filter intermodulation noise using a plurality of real-valued adaptive filters (e.g., adaptive filters configured to implement a real valued adaptive algorithm) configured to respectively filter noise components, (e.g., an in-phase (I) noise component and a quadrature phase (Q) noise component) distorting the received baseband signal, separately.

In particular, the transceiver 300 comprises an antenna 302 that is shared between a receiver and a transmitter section. The antenna 302 is coupled to a duplexer 304 that allows the transceiver 300 to operate in a continuous transmission/reception mode (e.g., a full-duplex mode). The duplexer may also be configured to reduce interference between the receiver and transmitter sections by selectively providing isolation (e.g., 50-60 dB of isolation) between the transmitter and receiver sections.

The receiver section may comprise one or more low noise amplifiers 314 and a mixer 316 (e.g., down conversion module) configured to convert an inbound RF signal into the inbound baseband or near baseband signal. The RF transmitter section may comprise an up-conversion module 320 and one or more power amplifiers 322 configured to convert an outbound baseband or near baseband signal into an outbound RF signal.

An adaptive filtering system 306 is configured to generate a plurality of system output signals S_{OUT} that are corrected to remove components of the intermodulation noise (e.g., an in-phase component and a quadrature phase component) generated in the non-ideal mixer 316 of the receiver path by a transmitted signal (e.g., parts of the TX signal leak via the duplexer into the receiver path and second order intermodulation noise is produced by the nonlinear characteristic of 316).

In one embodiment, the adaptive filtering system 306 comprises a first filtering path and a second filtering path configured to respectively generate system output signals, which can be collectively considered as a baseband signal, having different noise components removed. In one embodiment, the first filtering path is configured to generate a first system output signal, comprising a signal that is corrected to remove a first intermodulation noise component (e.g., a noise component that is distorting the in-phase component of a desired signal) generated by the transmission signal, and a second filtering path is configured to generate a second system output signal, comprising a signal that is corrected to remove a second intermodulation noise component (e.g., a noise component that is distorting the quadrature phase component of a desired signal) generated by the transmission signal.

It will be appreciated that by the use of first and second adaptive filtering paths that are independent of each other, intermodulation noise introduced into one path will have no affect on the other path. For example, intermodulation noise leaked into the I path will not be “seen” by the adaptive filter in the Q path (i.e., the filter in the Q path is not influenced by this noise). In contrast, if one complex filter (with cross-coupling between I and Q) is used, the filter output for the Q path will show a reaction on changes of the noise leaked into in the I path. Therefore, the use of two adaptive filters having no cross-coupling between the filtering paths can be detected if changing IM2 noise provided to one filtering path has no influence on the output signal of the other path.

In one embodiment, the adaptive filtering system 306 may be comprised within a digital front end (DFE) 308 having a first filtering path comprising adaptive filter 312a and a second filtering path comprising adaptive filter 312b. The adaptive filters 312a and 312b are respectively configured to estimate an intermodulation noise component based upon an adaptive filter input signal S_{IN} from the transmitter path and to subtract the estimated intermodulation noise component from a receiver signal S_{RX}. For example, the input signal S_{IN} is provided to a first adaptive filter 312a configured to operate a real valued adaptive algorithm to iteratively correct for a first noise component caused by the transmission signal. The input signal is also provided to a second adaptive filter 312b configured to operate a real valued adaptive algorithm to iteratively correct for a second noise component caused by the transmission signal.

In one embodiment, the DFE 308 may be configured to use an LMS algorithm to cancel the IM2 noise generated by the transmission signal at the output from mixer 316. LMS algorithms can be used by adaptive filters to find filter coefficients that produce the least mean squares of the error signal (e.g., difference between the desired and the actual signal). In particular, LMS adaptive algorithms may generate a compensation signal, which may be used to eliminate intermodulation distortion by appending the compensating signal to the receiver signal S_{RX}.

It will be appreciated that the even ordered intermodulation noise is proportional to the envelope of the transmission signal (e.g., second order intermodulation noise distorting the receivers' baseband signal is proportional to the squared envelope of the TX signal, fourth order intermodulation noise is proportional to the 4^{th} power of the envelope of the TX signal, etc.) Therefore, the adaptive filter input signal S_{IN} may be computed by an exponential circuit component 310 configured to generate an even power (e.g., n=2, 4, 6, 8, etc.) of the envelope of the transmission signal. In one embodiment, wherein the DFE is configured to cancel second order intermodulation noise (IM2) the exponential circuit component 310 may be configured to square the envelope of the transmitted signal (which is linear proportional to the magnitude of the baseband signal S_{TX}) to generate an input signal S_{IN} that is provided to the adaptive filters 312a and 312b, since IM2 noise is proportional to the squared envelope of the modulated blocker. In alternative embodiments, the exponential circuit component 310 may be configured to raise the magnitude of the transmitted baseband signal to alternative powers (e.g., n=4, 6, 8, etc.) to generate an input signal S_{IN} that is provided to adaptive filters to cancel intermodulation noise. In one embodiment, wherein the transmission signal comprises an I/Q signal, an envelope generator 309 may be configured to generate an envelope, from the I/Q signal, which is provided to the exponential circuit component 310.

Therefore, the adaptive filtering system of FIG. 3 separately filters components of an intermodulation noise from a receiver signal through the use of a plurality of adaptive filters configured to operate real valued adaptive filter algorithms to estimate components of an intermodulation noise.

FIG. 4 illustrates a more detailed block diagram of an adaptive filter 400 configured to operate a real valued LMS algorithm, as provided herein (e.g., corresponding to adaptive filter 312a or 312b in FIG. 3). As shown in FIG. 4, the adaptive filter 400 comprises three main components: a filter 402 configured to calculate an estimation of the intermodulation noise using a plurality of weight taps w(n), an adder 406 configured to generate an error signal (e.g., corresponding to S_{OUT} of FIG. 3) by comparing a desired output d(n) (e.g., corresponding to S_{RX} of FIG. 3) with a filter output y(n) estimating the intermodulation interference, and an adaptive processing component 404 (i.e., weight adjustment mechanism) configured to adjust the value of the weight taps.

In particular, an adaptive filter input signal u(n) (e.g., corresponding to S_{IN} of FIG. 3) that is based upon the transmitted signal (e.g., corresponding to S_{TX} of FIG. 3) in the transmission path, is provided to the filter 402 and the adaptive processing component 404. The filter 402 is configured to estimate the intermodulation noise signal and to generate an output signal y(n) that is based upon the convolution of the input signal u(n) and weighting taps w(n). The output signal y(n) is subtracted from a desired signal d(n), associated with an output signal from a mixer in the receiver path and potentially containing an undesirable intermodulation noise due to intermodulation noise caused by the transmitted signal, to generate an error signal e(n) that should be equal to the received signal with removed intermodulation noise. The error signal e(n) is feed back to the adaptive processing component 404, which then updates the weight taps w(n) to improve the noise estimation. Iterative operation of an adaptive filter algorithm causes the noise estimation to converge to a value that sufficiently cancels the intermodulation noise in the receiver signal.

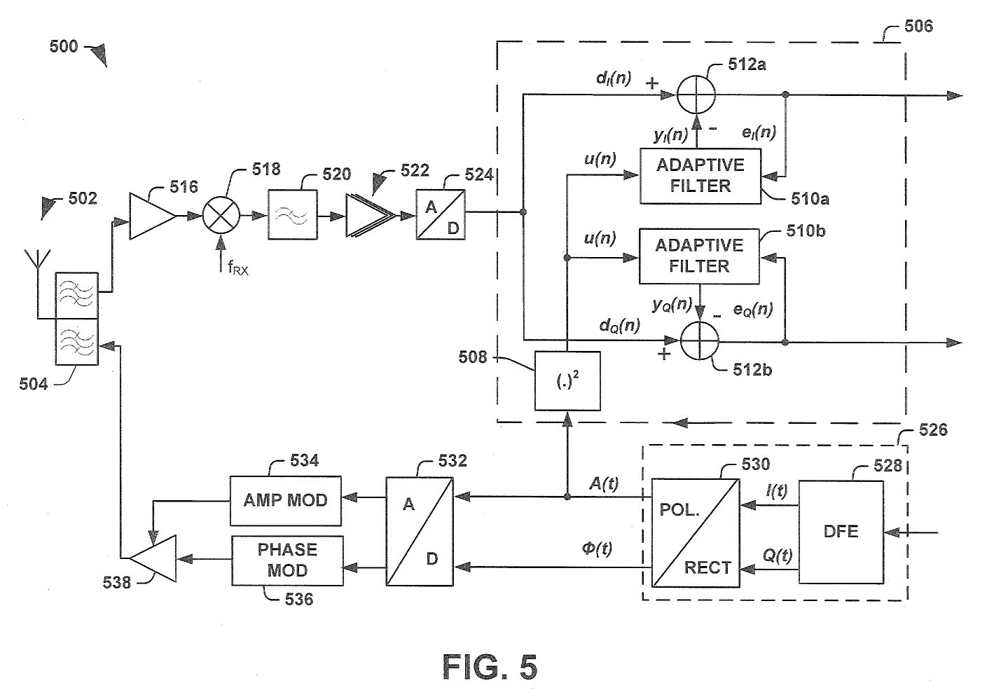

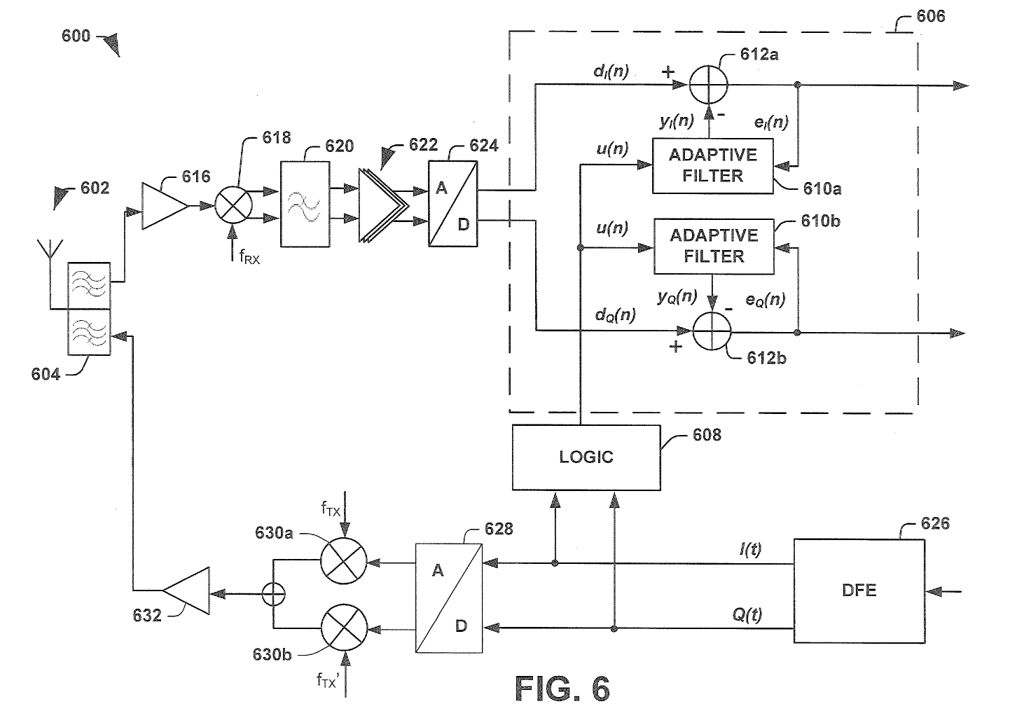

The simplified adaptive filtering system as provided herein may be implemented into a variety of transceiver systems. FIGS. 5-6 illustrate two exemplary embodiments of transceiver systems having an adaptive filtering system as provided herein. It will be appreciated that these embodiments are non-limiting embodiments that are intended to aid the reader in understanding and that do not limit the application of the adaptive filtering system as provided herein.

FIG. 5 illustrates block diagram of a polar modulation transceiver circuit 500 comprising an adaptive filtering system as provided herein configured to cancel second order intermodulation noise (IM2). The transceiver circuit 500 comprises a receiver path and a transmitter path. The receiver path is configured to demodulate a received signal. In one embodiment, the receiver path may comprise an amplifier 516, a mixer 518 (e.g., downconverter module), a filter 520, one or more amplifiers 522, and an analog to digital converter 524.

The transmission path of the polar modulation transceiver 500 comprises a processing unit 526 (e.g., a DFE, a baseband processor) configured to beak a transmitted signal unto an amplitude component A(t) and a phase component Φ(t). In one embodiment the processing unit may comprise a DFE 528 and a polar to rectangular conversion circuit 530. The output of the DFE 528 may comprise a transmission signal which can be separated into in-phase I(t) and quadrature phase Q(t) components. The in-phase I(t) and quadrature phase Q(t) components are then provided to the rectangular to polar conversion circuit 530 configured to convert the in-phase I(t) and quadrature phase Q(t) components into an amplitude component A(t) and a phase component Φ(t). A digital to analog converter 532 is configured to provide the phase component Φ(t) to a phase modulator 536 that modulates a radio frequency carrier signal having a constant signal envelope, and the amplitude component A(t) to an amplitude modulator 534 that varies a transmission signal envelope. A power amplifier 538 amplifies the modulated signal prior to transmission by antenna 502.

Since second order intermodulation noise (IM2) is proportional to the squared envelope of the transmission signal A(t), a DFE 506 comprises a squaring block 508 configured to square the amplitude component A(t) of the baseband transmission signal to generate an adaptive filter input signal u(n), which is provided to the first adaptive filter 510a and the second adaptive filter 510b as the input signal u(n).

The first adaptive filter 510a is configured to adapt the real parts of a weight vector w_{I}(n) at each sampling instant while minimizing the real error signals e_{I}(n). For example, the first adaptive filter 510a is configured to operate a real valued adaptive algorithm (e.g., LMS adaptive algorithm) that generates an output signal y_{I}(n) which is an estimate of a first component of intermodulation noise. The output signal is provided to an adder 512a that produces a real valued error signal e_{I}(n). The error signal e_{I}(n) is fed back to the adaptive filter 510a to iteratively update a tap weight vector w_{I}(n). Iterative operation of such an adaptive filtering process estimates the intermodulation noise distorting the in-phase component of the receiver signal y_{I}(n), and by cancelling the estimated noise generates an in-phase output signal e_{I}(n) having substantially no in-phase intermodulation noise.

The second adaptive filter is configured to adapt the its weight vector w_{Q}(n) at each sampling instant while minimizing error signals e_{Q}(n) in the imaginary component of the received signal. For example, the second adaptive filter 510b is configured to operate a real valued adaptive algorithm (e.g., LMS adaptive algorithm) that generates an output signal y_{Q}(n) that is an estimate of a second component of intermodulation noise. The output signal is provided to an adder 512b that produces an imaginary valued error signal e_{Q}(n). The error signal e_{Q}(n) is fed back to the adaptive filter 510b to iteratively update a tap weight vector w_{Q}(n). Iterative operation of such an adaptive filtering process estimates the intermodulation noise distorting the quadrature phase component of the receiver signal y_{Q}(n), and by cancelling the estimated noise generates a quadrature phase output signal e_{Q}(n) having substantially no quadrature phase intermodulation noise.

FIG. 6 illustrates an alternative embodiment of a transceiver system, wherein an I/Q transceiver 600 is configured to implement an adaptive filtering system as provided herein.

In particular, the transmission path of the I/Q transceiver 600 comprises a DFE 626 configured to generate an in-phase signal component I(t) and a quadrature phase signal component Q(t). The in-phase and quadrature phase components are provided to an digital to analog converter configured to provide an analog signal to upconverters 630a and 630b that generate an upconverted signal to a power amplifier 632 configured to amplify the upconverted signal prior to transmission by antenna 602. The in-phase and quadrature phase signal components are also provided to a logic circuit 608 that is configured to generate an adaptive filter input signal u(n) therefrom. In one embodiment, the logic circuit 608 may be configured to generate a magnitude from the I/Q signals and then to raise the magnitude to an even power.

As described above, the first adaptive filter 610a is configured to adapt the real parts of a weight vector w_{I}(n) at each sampling instant while minimizing the real error signals e_{I}(n). The second adaptive filter is configured to adapt the imaginary parts of a weight vector wan) at each sampling instant while minimizing the imaginary error signals e_{Q}(n).

Because a different adaptive filter is used to separately filter the I and Q components of the reference signal, there are no cross coupling effects between the filters in the I and Q paths. For example, estimations of the IM2 noise generated in one path (e.g., the in-phase path) have no effect on estimations of IM2 noise generated in the other path (e.g., the quadrature phase path). Accordingly, the apparatus provided herein reduces computational complexity of the adaptive filtering algorithm.

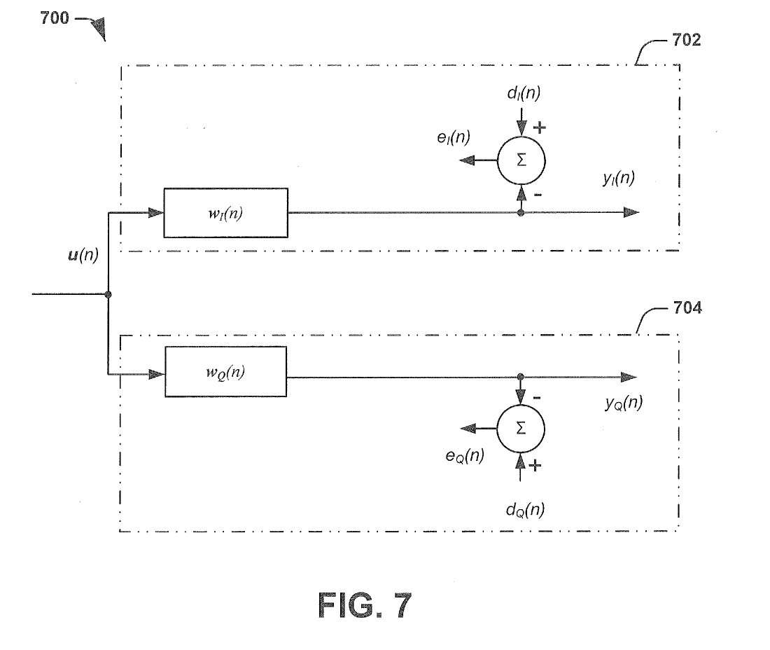

FIG. 7 illustrates a signal flow diagram 700 of two adaptive filters (e.g., corresponding to adaptive filters 510a and 510b) respectively configured to implement a real valued adaptive filtering algorithm (e.g., LMS algorithm) to cancel even ordered TX induced intermodulation noise in a receiver signal caused by a transmission signal.

Typically, the simultaneous adaptation of the real and imaginary parts of a weight vector operates with a cross relation between the real and imaginary components of an input reference signal u(n) (e.g., as shown in FIG. 2). However, the simplified adaptive filter allows for the cancellation of TX induced even-order intermodulation noise by simultaneously adapting the real and imaginary parts of the weight vector using separate adaptive filter paths, wherein each adaptive filter path is configured to operate using a simplified real valued algorithm (e.g., LMS algorithm). Therefore, respective adaptive filters operate without having to implement a complex algorithm that computes cross terms between the real and imaginary components of the input reference signal u(n).

In particular, the flow diagram illustrates the simplified adaptive filtering system use of two separate adaptive filters, illustrated by boxes 702 and 704, wherein each respective adaptive filter is configured to operate a real valued adaptive algorithm. The first adaptive filter 702 is configured to compensate for intermodulation noise using a real valued adaptive algorithm that generates an output signal y_{I}(n), while the second separate adaptive filter 704 is configured to compensate for intermodulation noise using a real valued adaptive algorithm that generates an output signal y_{Q}(n). Since the adaptive filters separately compensate for intermodulation noise the separate filters can be used, without interaction, to cancel noise to the output signal e_{I}(n) and the output signal e_{Q}(n) separately. This removes cross coupling between real and imaginary parts of the noise cancellation so that intermodulation noise cancellation can be performed for the in-phase component and the quadrature phase component respectively using a real valued adaptive algorithm for each path.

Operation of the adaptive algorithm as shown in FIG. 7, can be mathematically described for an adaptive filter as generating a filter output y(n) that is equal to the input signal u(n) convolved with a tap weight vector w(n) (i.e., y(n)=w^{H}(n)×u(n)). The iterative nature of the noise cancellation process relies upon iteratively searching for a tap weight vector that minimizes the mean square error between the desired signal and u(n). Therefore, the tap weight vector may be iteratively updated by stepping it by a value that is equal to the product of a step size μ (i.e., a convergence factor controlling the rate of adaption), the input signal u(n), and an error e(n) between the output signal y(n) and a desired signal d(n) (i.e., w(n+1)=w(n)+μu(n)e(n), wherein e(n)=d(n)−y(n)). Since each adaptive filter 702 and 704 is configured to generate an error signal e(n), having in-phase or quadrature phase components, the simplified adaptive filtering system provided herein also updates the filter coefficients w(n) based upon an error signal e(n) that comprises real or imaginary components.

The adaptive filtering algorithm shown in FIG. 7 can be applied to a transceiver system herein by representing the transmitted signal as x(t)=A(t) cos(ωt+Φ(t)). However, in even order intermodulation noise the adaptive input signal has no quadrature component u_{Q}(n)=0 and therefore the filtering function of the respective adaptive filters can be simplified to perform a real valued adaptive algorithm (e.g., imaginary quadrature phase components are equal to zero, leaving the in-phase components). Therefore, as shown in FIG. 7, the output signal of the first adaptive filter is equal to y_{I}(n)=w^{T}_{I}(n)u_{I}(n) and the output signal from the second adaptive filter is equal to y_{Q}(n)=w^{T}_{Q}(n)u_{I}(n).

Therefore, the signal flow diagram 700 illustrates how the use of two real valued adaptive filters can simplify an adaptive algorithm so that the in-phase and quadrature phase components of an intermodulation noise can be filtered separately and so that updating the filter coefficients w_{I}(n) and w_{Q}(n) can be done without the knowledge of signals in the other branch.

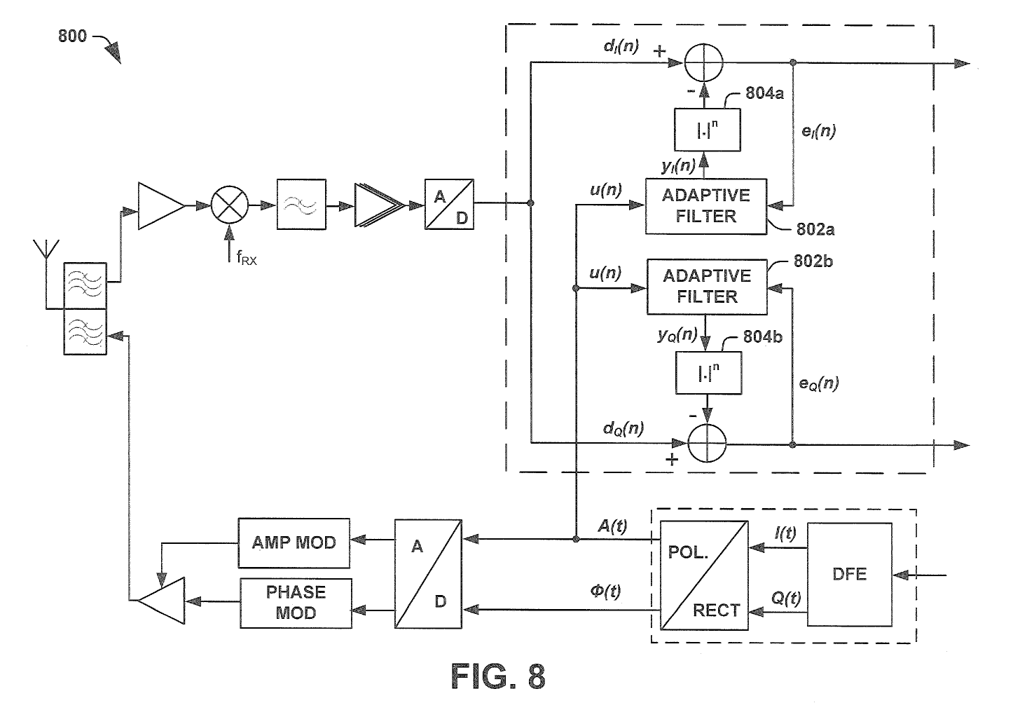

Although the simplified adaptive filters provided herein are illustrated as acting upon an amplitude of a transmission signal raised to a power (e.g., a squared amplitude of a transmission signal, as shown in FIG. 5), it will be appreciated that in one embodiment the simplified adaptive filters may be configured to operate on an magnitude (e.g., an un-squared magnitude) of a baseband transmission signal if the output of the simplified adaptive filters is raised to a power (e.g., squared). For example, FIG. 8 illustrates a block diagram of a transceiver 800 having simplified adaptive filters 802a and 802b configured to operate on the un-squared magnitude of a transmission signal. As shown in FIG. 8, the simplified adaptive filters 802a and 802b may be configured to operate on an un-squared magnitude of a TX signal if the output of the adaptive filters are provided to squaring blocks 804a and 804b, respectively configured to square an envelope of the output signals of respective adaptive filter.

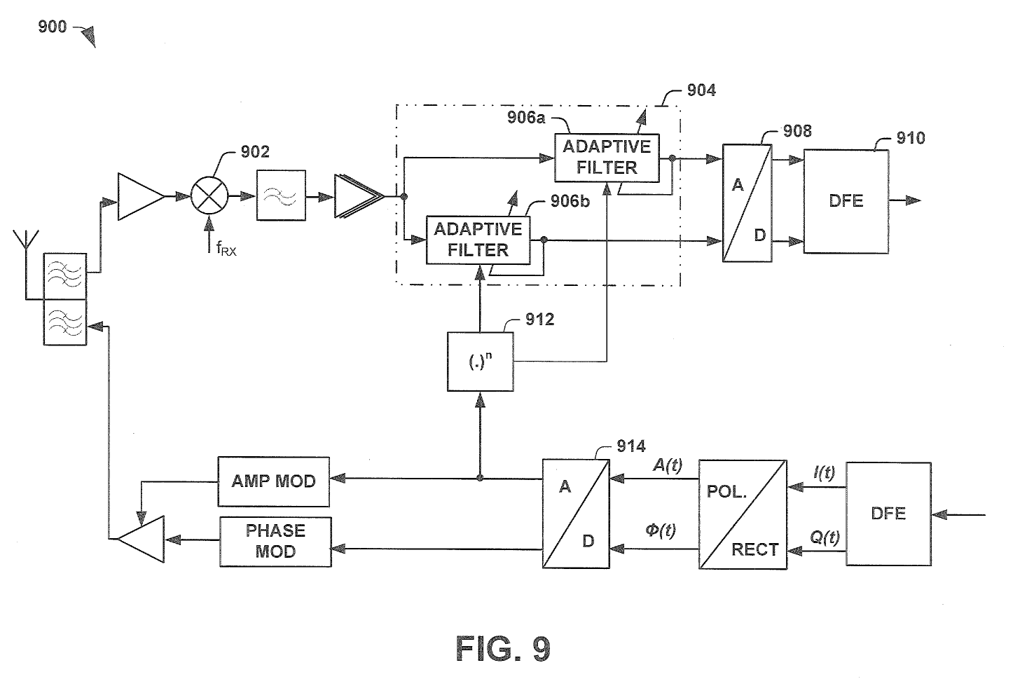

Although FIG. 8 illustrates a polar modulation transceiver circuit, it will be appreciated that this is a non-limiting embodiment. One of ordinary skill in the art will appreciate that simplified adaptive filters configured to operate on an un-squared magnitude of a transmission signal may be used in any of the disclosed embodiments provided herein (e.g., in an I/Q transceiver, in adaptive filtering systems configured to provide adaptive filtering in the digital domain, in adaptive filtering systems configured to provide adaptive filtering in the analog domain, etc.) Although the adaptive filtering systems described above (e.g., in FIGS. 3-6, and 8) are configured to provide adaptive filtering in the digital domain, it will be appreciated that the concept of utilizing two real valued adaptive filters to perform a complex adaptive filtering function may be used in the analog domain also. For example, FIG. 9 shows an exemplary block diagram of a transceiver 900 configured to implement a simplified adaptive filtering system to cancel transmitter induced even ordered intermodulation noise in the analog domain. The simplified adaptive filtering system is configured to operate a plurality of real valued adaptive algorithms in the analog domain to respectively cancel components of intermodulation noise induced by a transmission signal.

In particular, the transceiver 900 comprises an adaptive filtering system 904 comprising a first real valued adaptive filter 906a and a second real valued adaptive filter 906b configured to respectively operate real valued adaptive algorithms on analog signals to iteratively cancel components of an intermodulation noise caused by a transmission signal. The adaptive filtering system 904 is configured between the downconverter 902 and an analog to digital converter 908 configured to convert the analog filtered signal to a digital signal for digital signal processing by DFE 910. A squaring block 912 is configured downstream of a digital to analog converter 914 in the transmission chain so that the implementation of the real valued adaptive filters 906a and 906b is fully analog.

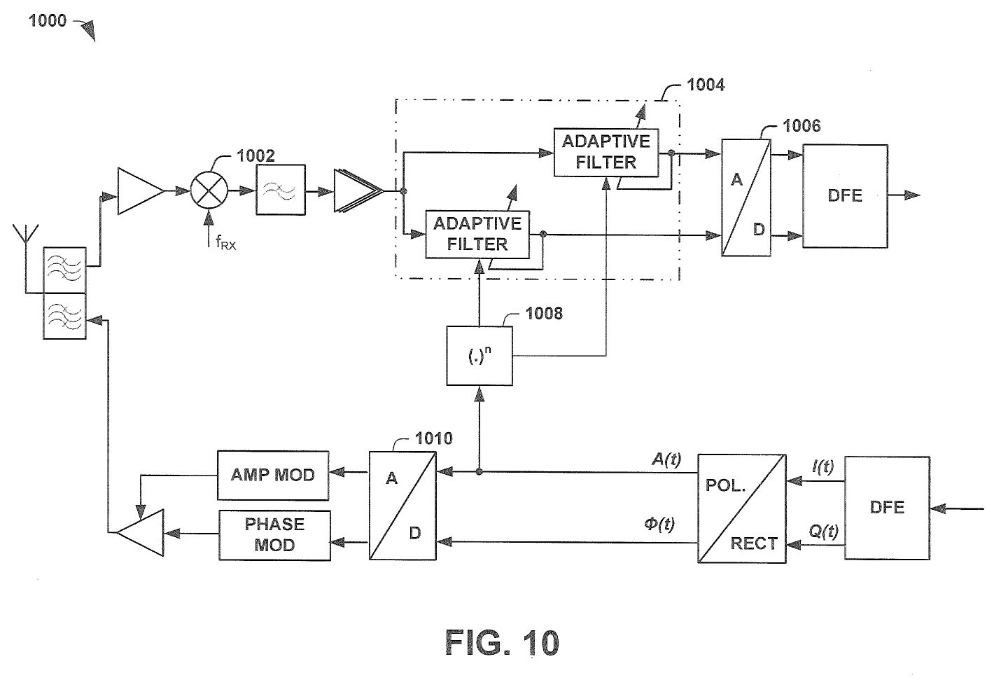

It will be appreciated that in additional embodiments, a transceiver, as provided herein, may be configured cancel transmitter induced even ordered intermodulation noise utilizing a circuitry that combines analog and digital processing. For example, as shown in the transceiver circuit of FIG. 10, calculation of the transmission signal magnitude may be performed in the digital domain (e.g., a squaring block 1008 is configured upstream of a digital to analog converter 1010 in the transmission chain) while cancellation of the intermodulation noise may be done in the analog domain (e.g., adaptive filtering system 1004 is configured between the downconverter 1002 and an analog to digital converter 1006 configured to convert the analog filtered signal to a digital signal). In an alternative embodiment, calculation of the transmission signal magnitude may be performed in the analog domain while cancellation of the intermodulation noise may be done in the digital domain.

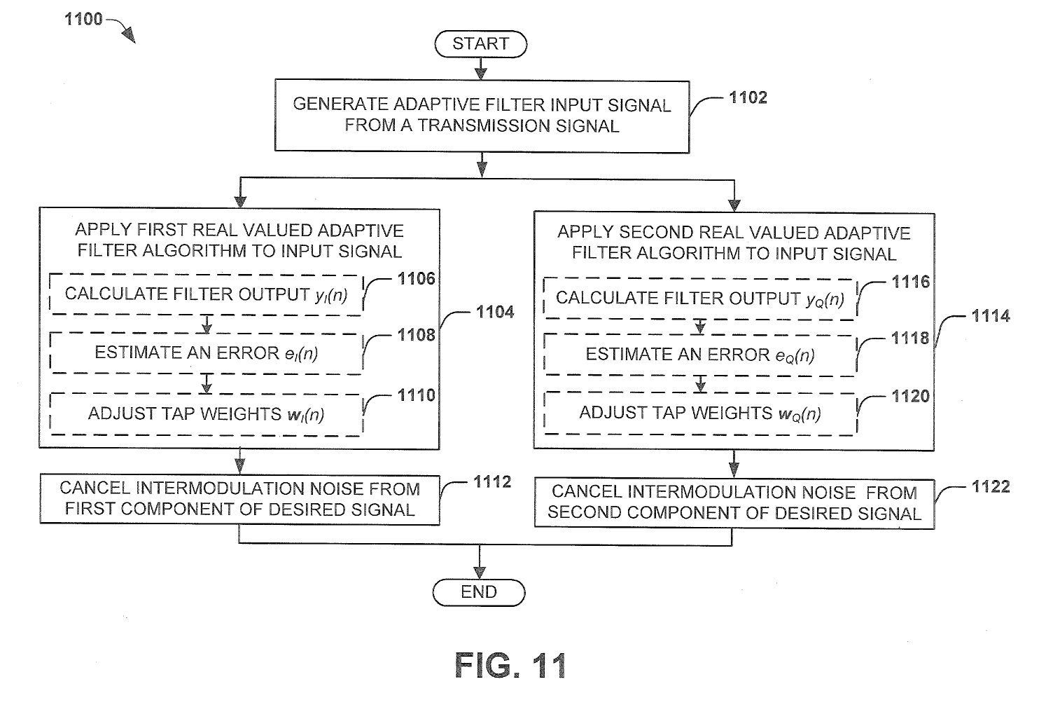

FIG. 11 is a flow diagram illustrating an exemplary method 1100 for cancelling transmitter induced even ordered intermodulation noise (e.g., second order intermodulation noise) in a receiver signal. The method relies upon cancelling estimated intermodulation noise through the use of an adaptive filtering system comprising a plurality of adaptive filters respectively configured to cancel the noise of a component of the transmitted signal.

While these methods are illustrated and described below as a series of acts or events, the present disclosure is not limited by the illustrated ordering of such acts or events. For example, some acts may occur in different orders and/or concurrently with other acts or events apart from those illustrated and/or described herein. In addition, not all illustrated acts are required and the waveform shapes are merely illustrative and other waveforms may vary significantly from those illustrated. Further, one or more of the acts depicted herein may be carried out in one or more separate acts or phases.

Furthermore, the claimed subject matter may be implemented as a method, apparatus, or article of manufacture using standard programming and/or engineering techniques to produce software, firmware, hardware, or any combination thereof to control a computer to implement the disclosed subject matter (e.g., the circuits shown in FIGS. 3, 5, 6, etc., are non-limiting examples of circuits that may be used to implement method 1100). The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

At 1102 an adaptive filter input signal is generated. The adaptive filer inputs signal may be generated from a transmission signal in the baseband (e.g., x(t)=I(t)+jQ(t)) to comprise a first component (e.g., an in phase component) and a second component (e.g., a quadrature phase component). In one embodiment, wherein the method is configured to cancel second order intermodulation noise, the input signal may be set equal to the square of the magnitude of the transmission baseband signal.

At 1104 a first real valued adaptive filtering algorithm is applied to the input signal. The first adaptive filtering algorithm is configured to iteratively determine a first intermodulation noise component caused by a transmission signal.

In one embodiment the adaptive filtering algorithm may comprise an LMS algorithm configured to estimate an in-phase component of intermodulation noise (e.g., a noise component that is distorting the in-phase component of a desired signal). In such an embodiment, the method may comprise iteratively calculating a filter output y_{I}(n) (at 1106), estimating an error signal e_{I}(n) (at 1108), and adjusting tap weights w_{I}(n) (at 1110).

At 1112 intermodulation noise is cancelled from a first (e.g., in-phase) component of the desired (receiver) signal. In one embodiment, cancellation of the first intermodulation noise generates a first output signal comprising a signal that is corrected to remove a first intermodulation noise component generated by the transmission signal.

At 1114 a second real valued adaptive filtering algorithm is applied to the input signal. The second adaptive filtering algorithm is configured to iteratively determine a second intermodulation noise component caused by a transmission signal.

In one embodiment the adaptive filtering algorithm may comprise an LMS algorithm configured to estimate a quadrature phase component of intermodulation noise (e.g., a noise component that is distorting the quadrature phase component of a desired signal). In such an embodiment, the method may comprise iteratively calculating a filter output y_{Q}(n) (at 1116), estimating an error signal e_{Q}(n) (at 1118), and adjusting tap weights w_{Q}(n) (at 1120).

At 1122 intermodulation noise is cancelled from a second (e.g., quadrature phase) component of the desired (receiver) signal. In one embodiment, cancellation of the second intermodulation noise generates a second output signal comprising a signal that is corrected to remove the second intermodulation noise component generated by the transmission signal.

Although the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A transmitter induced even-order intermodulation noise cancellation circuit, comprising:
a first real valued adaptive filter configured to receive an adaptive filter input signal based upon a transmission signal, to operate a real valued adaptive algorithm on the input signal to estimate a first component of an intermodulation noise, and to cancel the first component in a desired signal; and
a second real valued adaptive filter configured to receive the adaptive filter input signal, and to operate a real valued adaptive algorithm on the input signal to estimate a second component of the intermodulation noise, and to cancel the second component in the desired signal.

2. The circuit of claim 1, wherein the first component comprises a noise component that is distorting an in-phase component of the desired signal, and wherein the second component comprises a noise component that is distorting a quadrature phase component of the desired signal.

3. The circuit of claim 2, further comprising:
a receiver section comprising a non-ideal ( ) mixer with a nonlinear characteristic configured to downconvert a received inband signal to the desired signal;
a transmitter section comprising the transmission signal; and
a duplexer configured to couple the receiver section to the transmitter section;
wherein the transmitter induced intermodulation noise is generated in the nonlinear mixer of the receiver section by the transmitted signal leaking into the receiver section;
wherein the transmitter induced intermodulation noise is produced in the desired signal by the mixer or other nonlinear components.

4. The circuit of claim 2, wherein the first real valued adaptive filter and the second real valued adaptive filter are comprised within a digital front end (DFE) configured to cancel intermodulation noise from the desired signal.

5. The circuit of claim 2, further comprising:
a baseband processing circuit comprised within the transmitter section and configured to generate an in phase and a quadrature phase component; and
a logic circuit configured to generate the adaptive filter input signal from an in phase and a quadrature phase component of the transmission signal.

6. The circuit of claim 2, further comprising:
a digital front end (DFE) having in-phase and a quadrature phase input and output signals;
a rectangular to polar converter configured to receive the in phase and quadrature phase components and to generate therefrom an amplitude and a phase component; and
a logic circuit configured to generate the adaptive filter input signal from the amplitude of the transmission signal.

7. The circuit of claim 2, wherein the first and second real valued adaptive filters are configured to perform adaptive filtering of the desired signal in the analog domain.

8. The circuit of claim 2, wherein the intermodulation noise comprises a second order intermodulation noise, and wherein the logic circuit comprises a squaring block configured to square the magnitude of the transmission baseband signal.

9. The circuit of claim 1, wherein the first real valued adaptive filter estimates the first component of the intermodulation noise independent from the second adaptive filter, and wherein the second real valued adaptive filter estimates the second component of the intermodulation noise independent from the first adaptive filter.

10. A second order intermodulation noise (IM2) cancellation circuit, comprising:
an adaptive filtering system comprising a plurality of real valued adaptive filters configured to generate a plurality of adaptive filter output signals, respectively comprising a receiver signal corrected for a transmitter induced even-ordered intermodulation noise component, wherein each adaptive filter output signal is generated by a real valued adaptive filter configured to estimate the intermodulation noise component by operating a real valued adaptive filtering algorithm that is independent from the real valued adaptive filtering algorithms operated by a remainder of the plurality of real valued adaptive filters.

11. The circuit of claim 10, wherein the plurality of adaptive filters comprise:
a first real valued adaptive filter configured to receive an adaptive filter input signal, to operate a real valued adaptive algorithm on the adaptive filter input signal to estimate an in-phase intermodulation noise component, and to cancel the in-phase intermodulation noise component in an desired signal; and
a second real valued adaptive filter configured to receive the adaptive filter input signal, and to operate a real valued adaptive algorithm on the adaptive filter input signal to estimate a quadrature phase intermodulation noise component, and to cancel the quadrature phase intermodulation noise component in the desired signal.

12. The circuit of claim 11, further comprising:
a receiver section comprising a non-ideal mixer configured to convert a received signal to the desired signal;
a transmitter section comprising a transmission signal; and
a duplexer configured to couple the receiver section to the transmitter section;
wherein the transmitter induced even-ordered intermodulation noise is generated in the nonlinear mixer of the receiver section by the transmitted signal leaking into the receiver section.

13. The circuit of claim 12, further comprising:
a baseband processing circuit comprised within the transmitter section and configured to generate an in-phase and a quadrature phase component; and
a logic circuit configured to generate the adaptive filter input signal from an in-phase and a quadrature phase component of the transmission signal.

14. The circuit of claim 12, further comprising:
a digital front end (DFE) having in-phase and a quadrature phase input and output signals;
a rectangular to polar converter configured to receive the in-phase and quadrature phase components and to generate therefrom an amplitude and a phase component; and
a logic circuit configured to square the magnitude of the transmission baseband signal to generate the adaptive filter input signal, wherein the intermodulation noise comprises a second order intermodulation noise.

15. The circuit of claim 12, wherein the second order IM2 cancellation circuit is configured to perform signal processing in both the analog and digital domain.

16. The circuit of claim 10, further comprising:
one or more squaring blocks configured to respectively receive an output signal of one of the the adaptive filters and to square the magnitude of the adaptive filter output signal;
wherein the adaptive filter input signal comprises an un-squared magnitude of the transmission baseband signal.

17. The circuit of claim 10, wherein the adaptive filtering system is comprised within a digital front end (DFE) configured to cancel intermodulation noise from the desired signal.

18. A method for transmitter induced even ordered intermodulation noise cancellation, comprising:
generating an adaptive filter input signal from a transmission signal;
applying a first real valued adaptive filter algorithm to the adaptive filter input signal to estimate a first component of a transmitter induced even-order intermodulation noise;
applying a second real valued adaptive filter algorithm to the adaptive filter input signal to estimate a second component of the intermodulation noise; and
cancelling the first component and the second component of the intermodulation noise from a desired signal;
wherein the first and second real valued adaptive filter algorithms are independent from each other.

19. The method of claim 18, wherein the first component comprises an intermodulation noise component which is distorting an in-phase component of the desired signal, and wherein the second component comprises an intermodulation noise component which is distorting a quadrature phase component of the desired signal.

20. The method of claim 19, wherein the intermodulation noise comprises a second order intermodulation noise and wherein the adaptive filter input signal is generated by squaring the magnitude of a baseband transmission signal.
